(19) United States
(12) Patent Application Publication
(10) Pub. No.: US 2022/0414796 A1
(43) Pub. Date: Dec. 29, 2022

(54) COMPUTER IMPLEMENTED OIL FIELD LOGISTICS

(71) Applicant: Pilot Travel Centers, LLC, Knoxville, TN (US)

(72) Inventors: Chuck Sine, Knoxville, TN (US); David Cziep, Knoxville, TN (US)

(21) Appl. No.: 17/369,047

(22) Filed: Jul. 7, 2021

Related U.S. Application Data
(60) Provisional application No. 63/049,241, filed on Jul. 8, 2020.

(51) Int. Cl. G06Q 50/02; G06Q 10/06; G06Q 10/08

(52) U.S. Cl. CPC G06Q 50/02; G06Q 10/06311; G06Q 10/0833; G06Q 10/06398; G06Q 10/0838

(57) ABSTRACT

The present disclosure relates to systems and methods for providing a platform for managing the transportation of crude oil or any other resource, commodity, etc. In one aspect a system for oil field logistics is disclosed wherein the system utilizes a computer implemented dashboard. The system comprises a transport vehicle for transporting oil from oil field lease sites to destination locations. Further, an operator of the transport vehicle is equipped with a mobile computing device with GPS positioning. The system further includes a computing system configured to processes the transportation management system. The transportation management system comprises a database of oil field lease sites, as well as a database of registered operators, wherein the database of registered operators is populated by the operators registering for an account. The system further includes a route assignment module for assigning available operators to the oil field lease sites, as well as an operator request module for requesting available oil field lease sites, and a dashboard for unique user views.

### CROSS-REFERENCE

This application claims the benefit and priority of U.S. Provisional Patent Application No. 63/049,241 filed on Jul. 8, 2020, entitled “OIL FIELD LOGISTICS FOR A MOBILE APPLICATION,” the contents of which is herein incorporated by reference in its entirety.

### FIELD

The present disclosure relates generally to logistics software. More particularly, the present disclosure relates to route and lease management for delivery of fuels from oil lease sites.

### BACKGROUND

In the oil industry, crude oil is pumped from an oil field and delivered to a refinery where the crude oil is refined such that the oil can be used by consumers. The coordination of pickup and delivery is often a complex issue, essentially the difficulty lies in determining when crude oil may be picked up from numerous oil fields located throughout an area and then delivered to any number of stations or refineries. The complexity is similar to the traveling salesman problem (an NP-complete problem), wherein a multitude of factors determine the availability of operators, the available lease sites, and the optimization of routes. Therefore, there is a need in the field of crude oil delivery to logistically coordinate oil companies and operators (i.e., truck drivers) to schedule oil field locations, delivery destinations, routes, and more.

### SUMMARY

In one aspect a system for oil field logistics is disclosed wherein the system utilizes a computer implemented dashboard. The system comprises a transport vehicle for transporting oil from oil field lease sites to destination locations. Further, an operator of the transport vehicle. A mobile computing device with GPS positioning, wherein the operator is equipped with the mobile computing device. The system further includes an administrator. A transportation management system operatively configured to a computing system. The transportation management system comprises a database of oil field lease sites, as well as a database of registered operators, wherein the database of registered operators is populated by the operators registering for an account. The system further includes a route assignment module for assigning available operators to the oil field lease sites. As well as an operator request module for requesting available oil field lease sites, and a dashboard operatively configured to the transportation management system, wherein the dashboard has an administrative view and an operator view.

In another aspect a method for implementing a dashboard for oil field logistics is disclosed. The method comprises provisioning an operator with a mobile computing device equipped with a GPS module. Next, accessing on the operator's mobile computing device a transportation management system dashboard, wherein accessing is restricted to the operator view of the dashboard for the transportation management system. Then requesting, by the operator, a new oil field load request from the dashboard. Next, calculating, by the transportation management system, availability of an oil field lease site pickup that corresponds to the operator initiating the oil field load request. Then assigning, by the transportation management system an oil field lease site pickup and delivery destination based on at least the operator's oil field load request and confirming, by the operator's mobile computing device and the transportation management system, that the operator has arrived at the pickup location.

### BRIEF DESCRIPTION OF THE DRAWINGS

The foregoing summary, as well as the following detailed description of illustrative embodiments, is better understood with the following appended drawings. For the purposes of illustrating the embodiments, there are shown in the drawings example constructions of the embodiments; however, the embodiments are not limited to the specific systems, apparatus, and methods disclosed. In the drawings:

FIG. 1 is a diagram showing an example of a geographical area or map, including the locations of various “pickups” (e.g., leases) and “deliveries” (e.g., stations, refineries, etc.);

FIG. 2 is a diagram illustrating an example transportation management system for managing the transportation of oil from the pickups/leases to the deliveries/stations/refineries according to certain schedules;

FIG. 3 is a block diagram illustrating an example embodiment of the transportation management system shown in FIG. 2 for communication via the network also shown in FIG. 1;

FIG. 4 is a block diagram of an example embodiment of a computing device in which the transportation management system application is deployed;

FIG. 5 is a block diagram of an example embodiment of a dashboard view for the operator and the administrator showing work flows;

FIG. 6 is a flow diagram of an example embodiment of a workflow in the transportation management system;

FIG. 7 is a flow diagram of an example embodiment of an administrator workflow in the transportation management system;

FIG. 8 is an illustration of an example embodiment of a view of the administrator's dashboard wherein the administrator is creating routes;

FIG. 9 is an illustration of an example embodiment of a view of the administrator's dashboard wherein the administrator is assigning routes;

FIG. 10 is an illustration of an example embodiment of an administrator's dashboard view wherein it depicts inviting operators to the system;

FIG. 11 is an illustration of an example embodiment of an administrator's dashboard view wherein it depicts selecting users and adding users to routes;

FIG. 12 is a flow diagram of an example embodiment of a workflow for an operator;

FIG. 13 is an illustration of an example embodiment of a mobile application incorporating the transportation management system;

FIG. 14 is an illustration of an example embodiment of an operator dashboard depicting a request for new load;

FIG. 15 is an illustration of an example embodiment of an operator's dashboard with route selection, lease selection, and tank selection, further whether the load was witnessed or not;

FIGS. 16-21 illustrate example embodiments of an operator's dashboard and various activities and modules within the transportation management system.

FIG. 22 is an illustration of an example embodiment of an operator indicating the historical loads option.

FIG. 23 is an illustration of an example embodiment viewing of an operator viewing historical loads.

FIG. 24 is an illustration of an example embodiment of offline mode.

### DETAILED DESCRIPTION

Implementations and embodiments described herein can be understood more readily by reference to the following detailed description, drawings, and examples. Elements, system, and methods described herein, however, are not limited to the specific implementations presented in the detailed description, drawings, and examples. It should be recognized that these implementations are merely illustrative of the principles of the present disclosure. Numerous modifications and adaptations will be readily apparent to those of skill in the art without departing from the spirit and scope of the disclosure.

The present disclosure relates to systems and methods for providing a platform for managing the transportation of crude oil or any other resource, commodity, etc.

FIG. 1 is a diagram showing an example of a geographical area or map, including the locations of various “pickups” 102 (e.g., leases) and “deliveries” or “destinations” 104 (e.g., stations, refineries, etc.). A “pickup” or “lease” 102 may be a piece of property from which a resource (e.g., oil) may be obtained, such as by drilling, mining, etc. The piece of land may be leased to oil companies (or other resource collectors) to allow them to obtain the oil from the property. The pickup 102 (e.g., lease, piece of land, etc.) may be used according to a contract by which an owner of the land may conveys rights to the resource to an oil company or other party for the specific purpose of drilling for oil in exchange for an agreed upon price.

Between the pickups 102 and deliveries 104 (e.g., leases and stations/refineries) are a number of routes by which a delivery truck may be driven. It should be noted that the routes in reality may not necessary be straight (as shown), but more likely will follow various roads or other paths. One module within the transportation management system may be dedicated to the task of optimizing routes, typically by algorithmic means, depending upon variables such as pickup location, vehicle weight, vehicle size, route traffic, route speed, delivery destination, weather, and other parameters that may help define the route. Once such example is hill climbing, and random hill climbing, a localized search algorithm applying an iterative solution focusing on localized improvements. Another example is simulated annealing, wherein a “temperature” slowly decays from a positive value to zero, each step randomly selecting a solution similar to the current solution, measuring the quality and moving to it according to the “temperature-dependent” probabilities of selecting better or worse solutions. The simulated annealing algorithm may represent s as state zero, and k for a set of steps, wherein the temperature T decays as (k+1/k max), and s new selects a random neighbor based on at least the decay schedule. Further, a neural network or a genetic algorithm may be applied to the pickup and delivery location, wherein the algorithms may configure with additional parameter such as the vehicle weight, vehicle size, route traffic, route posted speed, route achieved speed, construction, weather, and other parameters that may influence an optimization algorithm. The above algorithms represent two example embodiments incorporated within the transportation management system that may be used by administrators or by the system to generate routes from pickup 102 locations to delivery 104 addresses.

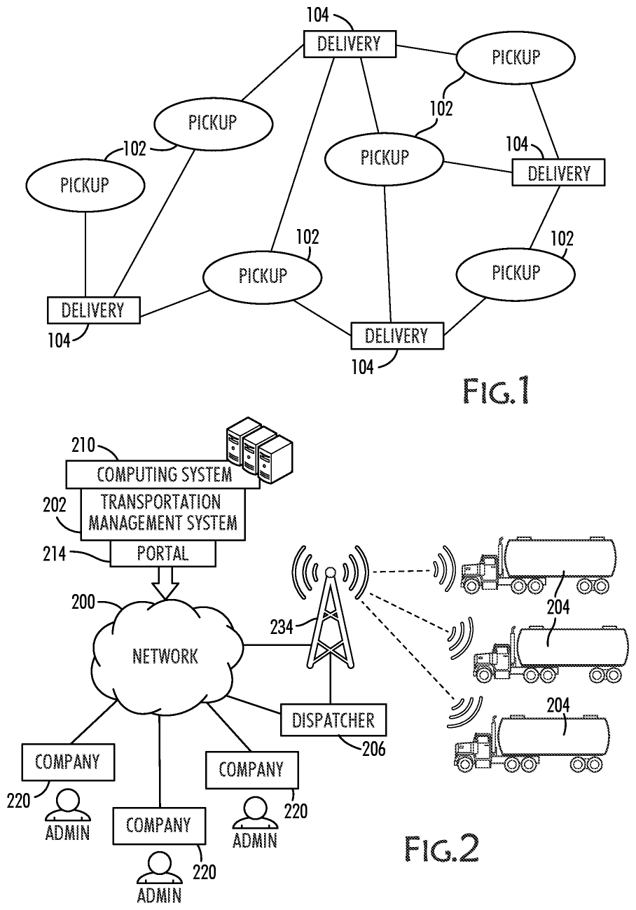

FIG. 2 is an example system for managing the transportation of oil from the pickups/leases to the deliveries/stations/refineries according to certain schedules. As shown in FIG. 2, a transportation management system 202 is configured within a computing system 210 to oversee the various functions and processes involved in the coordination of the transportation of a resource (e.g., oil) from the number of leases to any of the various refineries. In the example, the portal 214, also referred to as the dashboard of the transportation management system, has two depicted levels of access, or user access control. In other embodiments there may be three or four or as many levels of access control to provision at least the administrator role and the operator role, but may include computer administrator privileges or other privileges as necessary.

Communication to the transportation management system 202 may be allowed through a portal 214 or dashboard, such as a web portal or application on a mobile phone that grants access the various functions of the transportation management system 202 installed on a computing system 210, often the computing system 210 is a cloud system such as an Amazon Web Server™ or Microsoft Azure™ that allows provisioning of applications. In other embodiments the computing system 210 may be a localized server, or may be deployed on regional level servers. Similarly, the transportation management system and dashboard may be deployed on a server and accessed through a URL or website that provisions the login screen for the various dashboard views, such as the operator view and the administrator view.

During a setup process of the transportation management system 202, one or more companies 220, each having one or more administrators (or “admins”), may be configured to sign up for service provided by the transportation management system 202. The companies 220 may represent oil companies or other entities. In some embodiments, the companies 220 may own one or more of the leases, but do not necessarily have to own any leases. The companies 220 may also own one or more of the refineries, but do not necessarily have to own any refineries. Also, the companies 220 may own one or more truck 204 (e.g., tanker trucks or simply “tanks”), but do not necessarily have to own any trucks (such as in the situation where the company uses truck drivers and trucks on a contract basis.

Truck drivers, referred to herein as “operators,” are configured to drive the truck 204 to the various pickup locations (e.g., leases, oil fields, etc.), have the oil pumped into the tank, and then deliver the oil load from the lease to one of the delivery locations (e.g., stations, refineries, etc.) according to the schedule set up by the companies. The operators may be associated with the companies 220 or may work independently or for a third party trucking company. The operators may be configured to communicate with the transportation management system 202 using a mobile device, such as a smart phone or other built-in communication system on the truck. The mobile devices may use cellular service and communicate via cellular towers 234, satellite, etc. The cellular towers 234 and other mobile communication systems may be connected to a network 200 (e.g., the Internet, local area network). Also, the transportation management system 202 may communicate with the operators via the portal 214, network 200, and cellular towers 234, etc.

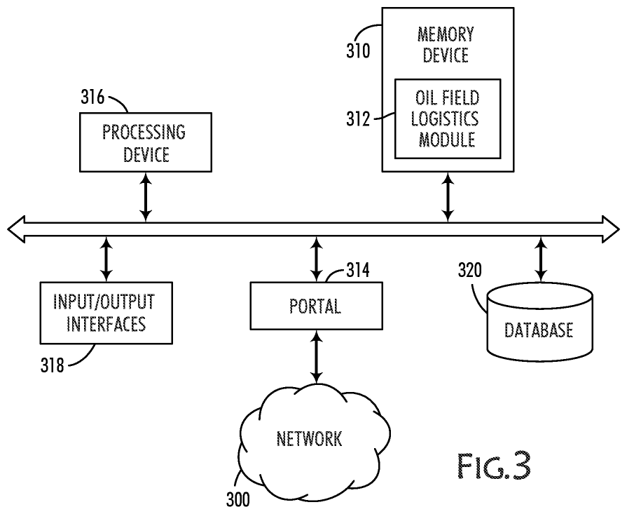

FIG. 3 is a block diagram illustrating an embodiment of the transportation management system shown in FIG. 2 for communication via the network (pickups and deliveries) shown in FIG. 1. In the illustrated embodiment, the transportation management system may be a digital computer that, in terms of hardware architecture, generally includes a processing device, a memory device, input/output (I/O) interfaces, and a network interface. The memory device 310 may include a data store, database, or the like. The memory device is typically non-transitory memory and holds the transportation management system and the various logistics modules for execution by the processing device 316. It should be appreciated by those of ordinary skill in the art that FIG. 3 depicts the transportation management system in a simplified manner, where practical embodiments may include additional components and suitably configured processing logic to support known or conventional operating features that are not described in detail herein. The components (i.e., additional storage, processing units, other peripherals) are communicatively coupled via a local interface. The local interface may be, for example, but not limited to, one or more buses or other wired or wireless connections. The local interface may have additional elements, which are omitted for simplicity, such as controllers, buffers, caches, drivers, repeaters, receivers, communications modules, among other elements, to enable communications. Further, the local interface may include address, control, and/or data connections to enable appropriate communications among the components.

The processing device 316 is a hardware device adapted for at least executing software instructions. The processing device may be any custom made or commercially available processor, a central processing unit (CPU), an auxiliary processor among several processors associated with the transportation management system, a semiconductor-based microprocessor (in the form of a microchip or chip set), or generally any device for executing software instructions. When the transportation management system is in operation, the processing device may be configured to execute software stored within the memory device, to communicate data to and from the memory device, and to generally control operations of the transportation management system pursuant to the software instructions.

It will be appreciated that some embodiments of the processing device described herein may include one or more generic or specialized processors (e.g., microprocessors, Central Processing Units (CPUs), Digital Signal Processors (DSPs), Network Processors (NPs), Network Processing Units (NPUs), Graphics Processing Units (GPUs), Field Programmable Gate Arrays (FPGAs), and the like). The processing device may also include unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry” or “logic” that is “configured to” or “adapted to” perform a set of operations, steps, methods, processes, algorithms, functions, techniques, etc., on digital and/or analog signals as described herein for the various embodiments.

The I/O interfaces 318 may be used to receive user input from and/or for providing system output to one or more devices or components. User input may be provided via, for example, a keyboard, touchpad, a mouse, and/or other input receiving devices. The system output may be provided via a display device, monitor, graphical user interface (GUI), a printer, and/or other user output devices. I/O interfaces 318 may include, for example, a serial port, a parallel port, a small computer system interface (SCSI), a serial ATA (SATA), a fiber channel, InfiniBand, iSCSI, a PCI Express interface (PCI-x), an infrared (IR) interface, a radio frequency (RF) interface, and/or a universal serial bus (USB) interface.

The network interface 300 may be used to enable the transportation management system to communicate over a network, such as the network, the Internet, a wide area network (WAN), a local area network (LAN), and the like. The network interface 300 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 300 may include address, control, and/or data connections to enable appropriate communications on the network. In one example a communications module is embedded on a system on a chip, in another example a communications module may be plug and play, or otherwise a standard communications module through a PCI interface.

The memory device 310 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the memory device 310 may incorporate electronic, magnetic, optical, and/or other types of storage media. The memory device 310 may have a distributed architecture, where various components are situated remotely from one another, but can be accessed by the processing device. The software in memory device 310 may include one or more software programs (transportation management system), each of which may include an ordered listing of executable instructions for implementing logical functions. The software in the memory device 310 may also include a suitable operating system (O/S) and one or more computer programs. The operating system (O/S) essentially controls the execution of other computer programs, and provides scheduling, input-output control, file and data management, memory management, and communication control and related services. The computer programs may be configured to implement the various processes, algorithms, methods, techniques, etc. described herein.

The memory device 310 may include a data store used to store data such as a relational database or other database 320. In one example, the data store may be located internal to the transportation management system and may include, for example, an internal hard drive connected to the local interface of the computing system that is executing the transportation management system. Additionally, in another embodiment, the data store may be located external to the transportation management system and may include, for example, an external hard drive connected to the I/O interfaces (e.g., SCSI or USB connection). In a further embodiment, the data store may be connected to the computing system through a network (e.g. cloud network) and may include, for example, a network attached file server.

Moreover, some embodiments may include a non-transitory computer-readable storage medium having computer readable code stored in the memory device 310 for programming the transportation management system or other processor-equipped computer, server, appliance, device, circuit, etc., to perform functions as described herein. Examples of such non-transitory computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by the processing device 316 that, in response to such execution, cause the processing device 316 to perform a set of operations, steps, methods, processes, algorithms, functions, techniques, etc. as described herein for the various embodiments.

As shown, the memory device 310 may include software, such as an oil field logistics module 312, which can be used to allow the transportation management system to control the various functions described herein. The oil field logistics module 312 may include processes for establishing the companies to allow them to utilize the routing and distribution scheduling services that are offered. Further, the oil field logistics module 312 may be incorporated into the transportation management system and may be used to process the optimization algorithms as discussed earlier. In addition to setting up companies for the service, an admin of each company can have an account, which allows them to perform certain tasks as described herein such as creating routes, creating leases, loading leases, loading routes, assigning routes based on at least the transportation management system. Also, the operators can also download a mobile application (“app”) on their mobile devices to allow them to request pickups and perform other actions such as viewing the history of trips such as a log file, the route to be taken, the weather, and other features as disclosed herein.

The oil field logistics module (POL) of the transportation management system allows the Administrator of each company to perform the following actions:
Customer Administrator invited to POL dashboard
Creating routes
Assigning leases to routes
Inviting Operators
Assigning routes to operators

The oil field logistics module (POL) of the transportation management system allows the Operator to perform the following actions:
Creating a POL account
Downloading the Pilot Oilfield Logistics Mobile App and logging in
Requesting a new load
Active loads
Historical loads
Unconfirmed loads/Offline mode

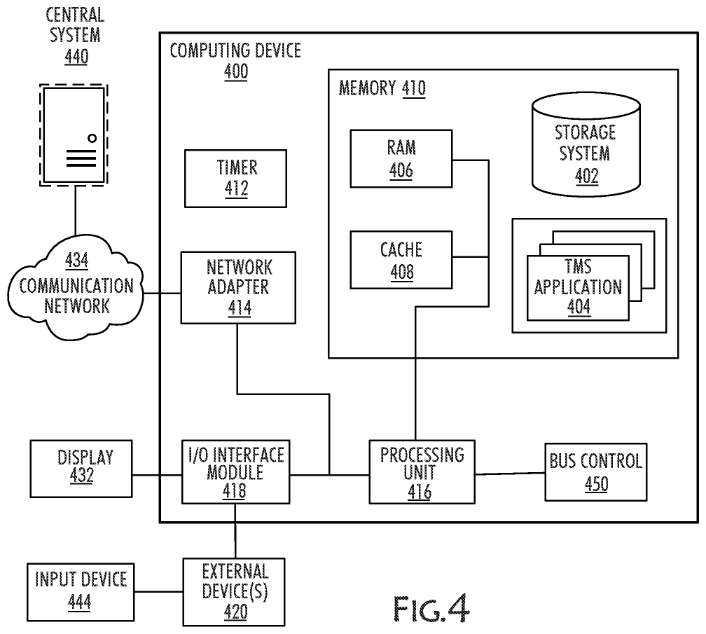

FIG. 4 is a block diagram of an example of a computing device 400 which outlines the basic structure in further detail from FIG. 3 and includes features that may be present in both the operators device and the administrators device, as well as any cloud computing device such as a server or a local server. The computing device for the operator may be a mobile phone such as an Apple iPhone™ or a Samsung Galaxy™, or other “smart” phone or tablet computer with at least the hardware identified in FIG. 4 and with some degree of portability, including a module for global positioning (GPS) module that allows administrators to view operator locations. The computing device for an administrator may be a desktop computing device, or a tablet, or a mobile computing device such as a smart phone. As discussed above, the storage system 402 may be a relational database or any database capable of storing data for use in the transportation management system application 404 and or dashboard view. The memory 410 is a global definition for several memory components such as random access memory (RAM) 406, cache memory 408, and storage system 402 or storage unit. Within the memory 410 resides the transportation management system application and any derivative modules or applications thereof such as the oil field logistics module. Often times the principal application, the transportation management system application may have sub applications such as the POL application, wherein they may be separated out into modules such as object code defines. Further, the transportation management system application may be equipped with different “dashboard” views, dashboards are unique views for the particular access permission. For example, an administrator view will depict an administrator's options and choices within the system, such as inviting operators, assigning leases to operator routes, creating operator routes, assigning routes to operators, and confirming operators are at specific locations such as pickup and delivery sites. Similarly, an operator view will depict the operator's options and display a unique view with operator commands and selections, such as creating an operator account, requesting new loads, inquiring on active loads, checking for unconfirmed loads, and viewing historical loads.

Continuing with FIG. 4, the processing unit 416 executes instructions, and the bus control 450 controls the flow of instructions throughout the computing device 400. The timer 412 maintains the clock on the computer and for various other reasons such as the GPS module on the network adapter 414 may serve as an aid in positioning on mobile computing devices. The network adapter 414 facilitates communications and allows contact to a remote server through a communication network 434, wherein the communication network may comprise cellular, wireless, ground based, satellite, and through a various set of standards (e.g. 5G, LTE, edge).

The i/o interface module 418, as discussed in FIG. 3 facilitates the addition of external devices 420 such as input devices 444 and other external devices 420 such as monitors and displays 432, cameras, GPS modules, LIDAR, communication adapters, and more. The computing device 400 is a simplification of many systems, and one skilled in the art will immediately recognize the hardware aspects required to perform the disclosure herein.

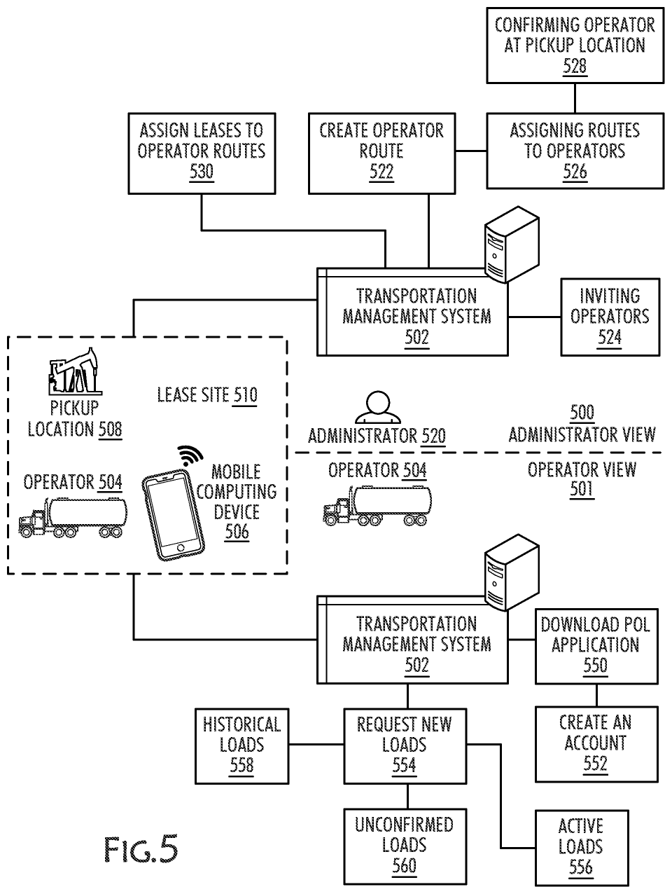

FIG. 5 is block diagram of an example embodiment of a dashboard view for the operator and the administrator showing work flows. The example includes the two views (administrator and operator) along with the interaction between the administrators and operators utilizing the transportation management system 502, and any sub modules such as the POL module. Depicted in the example of FIG. 5 is a vehicle for transporting oil from oil field lease sites 510 to destination locations via an operator 504. The lease sites 510 typically have a designated pickup location 508, wherein the operator 504 in the vehicle equipped with a mobile computing device 506 or a computing device with a GPS module can check in or otherwise provide feedback to an administrator confirming the operator 504 and vehicle are at the pickup location 508 and 528. The operator 504 is often transmitted route instructions from the transportation management system 502, and may be in coordination with an administrator 520. In this example the transportation management system 502 is operatively configured to a computing system, such as a cloud server, wherein the administrator 520 and the operator 504 are presented with dashboard view of the system, the administrator view 500, and the operator view 501. The dashboard views allow for transmitting and receiving contents from the transportation management system 502. The transportation management system 502 is connected to a database, wherein the database may hold a variety of information such as oil field lease sites, oil field lease contracts, registered operators, registered administrators, and the like, including the ability to be used as a repository for route management, maps and other information storage as it relates to the transportation management system 502 and any subsystems. One example of data entry, the transportation management system may take as input operators that sign up or follow registration hyperlinks or directions as provided by administrators, customers, or the transportation management system itself.

The transportation management system may have several modules within it, such as the oil field logistics module (POL), a route assignment module, an operator request module, a lease assignment module, and a pickup or delivery confirmation module. In one example, a route assignment module 526 assigns routes to specific pickup locations at lease sites 510, and delivery address in which the contents that the operator 504 has acquired will be deposited at. In another example a route assignment module 526 (as discussed in route optimization above) may be used to assign routes based on operator 504 proximity, truck size, truck capability, mileage, previous trips, weather, and a multitude of factors that would allow for optimization of registered available operators. In another example, an operator request module 554 is utilized for requesting available oil field lease sites. Wherein the operator request module 554 requests new loads from the transportation management system 502, the transportation management system identifies new load opportunities and assigns the new loads along with routes through the route assignment module 526. There are a host of other modules and features, all which may be conveyed by the respective dashboard views, namely, the administrators view 500 and the operators view 501.

Referring to FIG. 5, an example typical workflow as an administrator 520 may involve logging into the administrator view 500 and accessing the transportation management system 502 modules. Including inviting operators, wherein inviting operators may send an email or a text invitation with a link to become an operator 504 for a company on the transportation management system 502. The invitation may further grant access rights and use of the operator view 501 of the transportation management system 502 dashboard. In the operator view 501 the operator may be given access to the request new loads feature 554 of which has field such as viewing historical loads 558, checking unconfirmed loads 560, where the unconfirmed load is a requested load that is pending within the transportation management system 502. A pending load may be a load that's route is not optimized or a lease site that is set to open at a specific time, or otherwise is placed on hold until acceptance from an administrator 520 or from the transportation management system 502 is transmitted. An additional feature to the invitation from an administrator is a hyperlink to an application store such as Apple's App Store or Google's Play Store for downloading of the POL application 550 that grants access to the transportation management system 502 and the various modules disclosed herein. Often times the POL module or application may serve as the dashboard view and assimilate directly with the transportation management system 502. Once downloaded the POL application allows for account creation so that the operator 504 can begin service without the need to have access to a traditional computing desktop or laptop.

In the example workflow for an administrator a login screen may be presented under the administrator view 500, wherein the administrator 520 may be use issued credentials from the company or from the transportation management system 502. From the administrator's view 500 the administrator 520 may invite operators 524, and may attend to organizing with the transportation management system 502 additional module that handle operations such as assigning leases to operator routes 530. Wherein assigning leases to operator routes 530 may comprise querying a database of available lease sites 510, querying a database of available operators and vehicles, and coordinating based on the available load requests from operators the most efficient and optimized routes for operators 504 to pickup locations 508 to destination sites. The transportation management system 502 either alone or in coordination with the administrator may create operator routes 522, assign the routes to operators 504 that have requested new loads 554, and confirm the operator is at the pickup or destination location.

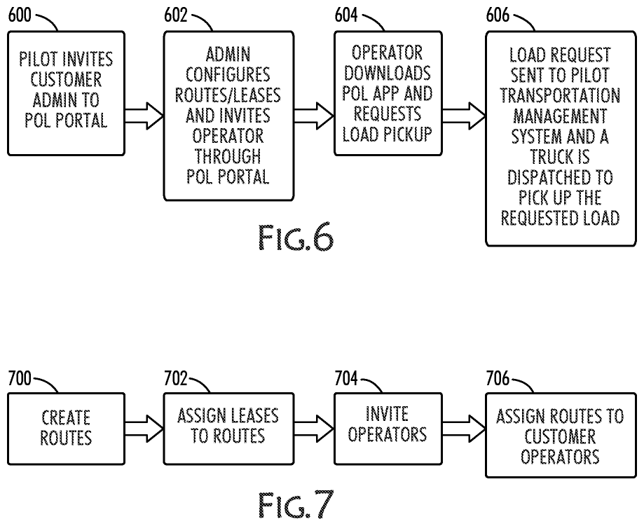

FIG. 6 is a flow diagram of an example simplified method where the transportation management system (in this example “Pilot™”) invites customer admin to Pilot Oilfield Logistics™ (POL) portal 600 for the transportation management system. The admin configures routes/leases according to their oil delivery needs and invites operators through the POL portal 602. The operator downloads POL app onto his/her mobile device and requests load pickups 604. Next, the load request is sent to Pilot™ transportation management system and a truck is dispatched to pick up the requested load 606. This flow chart describes the operator flow from FIG. 5 with a straightforward progression of steps a customer may take to begin utilizing operators on an owned and provisioned transportation management system.

FIG. 7 is an example embodiment depicting a flow chart of a process of an administrator or Admin may take within the transportation management system. The steps include creating routes 700, assigning leases to routes 702, inviting operators 704, and assigning routes to customer operators 706. These steps are necessary to enable Operators to start requesting load pickups once logged in as an Admin. Additional steps may be added such as provisioning new routes, and optimization of routes, as described herein. In the example of FIG. 7 a route may be created utilizing the optimization engine/module as discussed earlier, and may take into account the lease site location, and available operators. The algorithm within the module may solve for the shortest distance, the safest pathway, and may also add parameters for vehicle size thereby calculating routes that area available for larger tanker trucks and vehicles.

FIG. 8 is an illustration of an example embodiment of a view of the administrator's dashboard wherein the administrator is creating routes, including the steps:
1. Navigate to the “Routes and Leases” tab
2. Select “Create”
3. Enter a route name
4. Select “Save”

At least one route must be created in order to assign leases and enable Operators to request loads. Often times the transportation management system may create the routes based off at least the database of relevant information, including available lease sites and available operators requesting loads, and the optimization thereof.

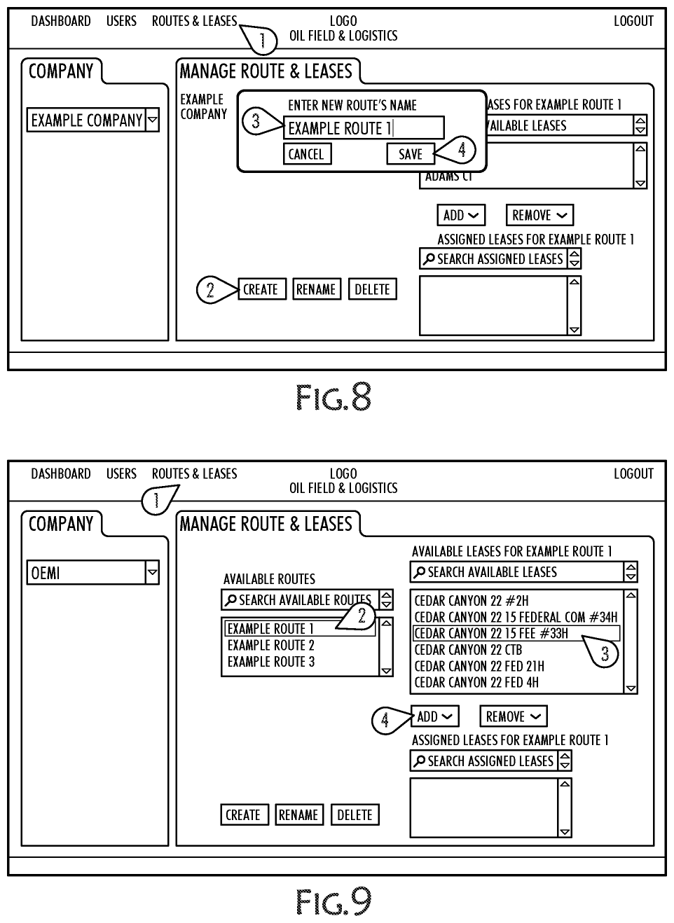

FIG. 9 is an illustration of an example embodiment wherein the administrator is assigning leases to routes, which may include the steps:
1. Navigate to the “Routes and Leases” tab
2. Select a route
3. Select a lease
4. Select “Add”

Leases can be assigned to multiple routes. Furthermore, leases can be assigned to multiple operators as well as managed and changed in real time through the transportation management system.

FIG. 10 is an illustration of an example embodiment showing the steps for Inviting Operators, where:
1. Navigate to the “Users” tab
2. Enter the operator's name and email address
3. Select “Operator” role
4. Click “Invite”

The operator will receive an email or text message invitation link to setup their account so they can log in to the POL app or the dashboard interface for the transportation management system. A customer admin or administrator can invite other customer admins from this screen by selecting the appropriate role in step 3. Users can be assigned both roles, operator and administrator, at the same time if the desired effect is for testing or analysis and the permissions are granted.

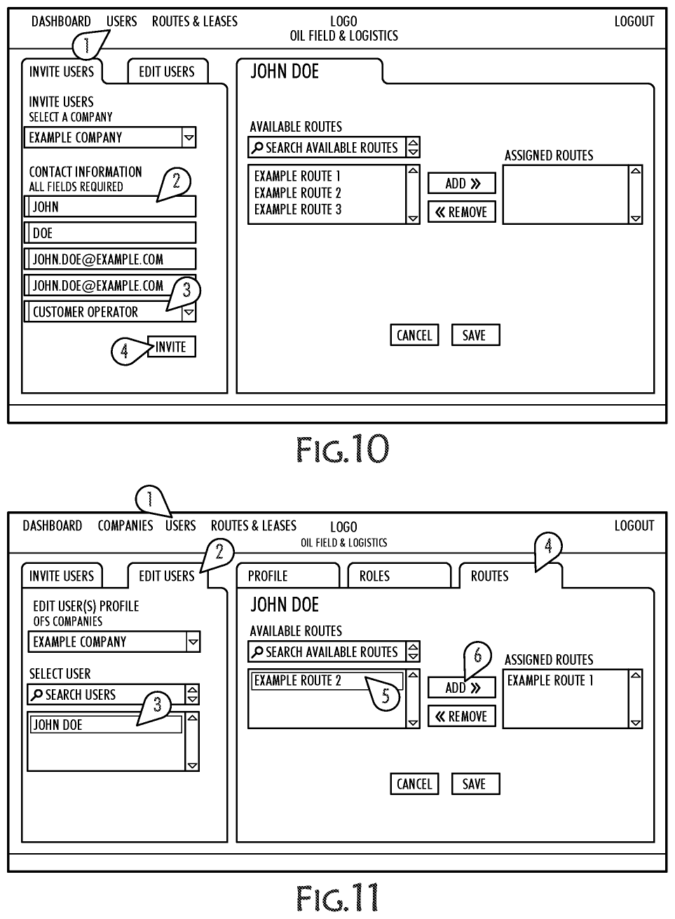

FIG. 11 is an illustration of an example embodiment of an administrator's dashboard view wherein it depicts a process for Assigning routes to Operators, which may include the Administrator or Admin steps of:
1. Navigate to the “Users” tab
2. Select the “Edit Users” sub-tab
3. Select an Operator
4. Select the “Routes” tab
5. Select from available routes
6. Click “Add”

Added routes will appear under “Assigned Routes”—these are the routes the selected user will be able to manage from the POL mobile app and/or the transportation management system dashboard by connecting with the transportation management system through the operator view dashboard. In other examples the transportation management system will assign routes by optimization of the available parameters as discussed previously.

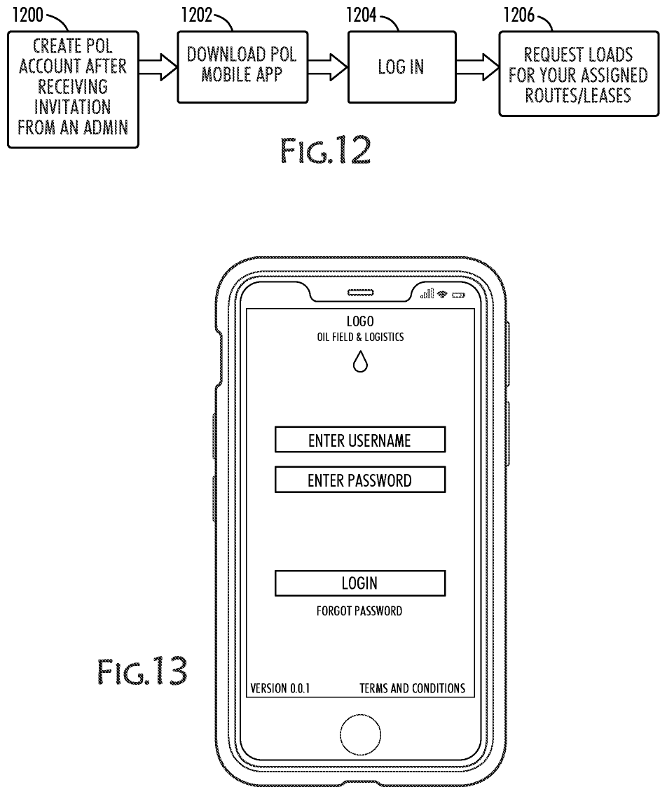

FIG. 12 is flow diagram illustrating a process for the Operators. This process may include creating POL account after receiving an invitation from an Admin, downloading the POL mobile app on their mobile device, logging in, and requesting loads for their assigned routes/leases.

FIG. 13 is an illustration of an example embodiment of a mobile device using the oil field logistics module (“POL”) of the transportation management system (“transportation management system”) for an administrator. The customer administrator is invited to POL portal by the following steps.
1. A Pilot Admin will invite you to create a POL Portal account.
2. The administrator may receive the following message: You will receive an email invitation from donotreply@pilottravelcenters.com—the subject line will be “Pilot Oilfield Logistics—Account Creation”. The invitation link expires within 24 hours, but a Pilot Admin can send another invitation link if needed.

Additional detail of the invitation process includes:
3. Follow the email invitation link to set your POL Portal account password. The password requirements may include:
   8 character minimum
   At least one upper case
   At least one lower case
   At least one number
   At least one special character from the following: !@#$\hat{ }&
4. Once the password is set, follow the POL Portal link to log in

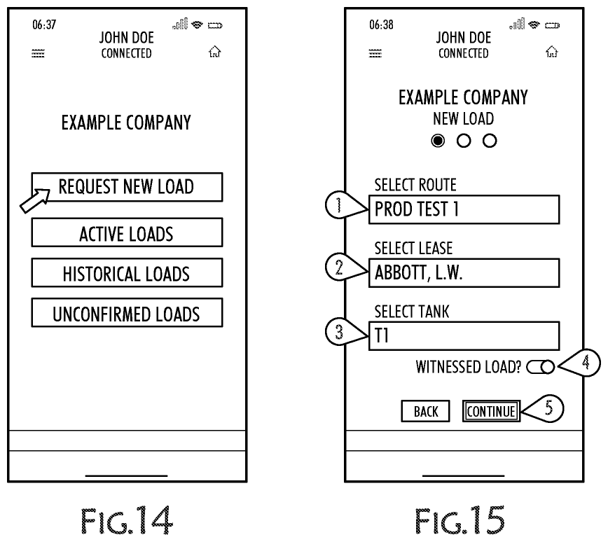

Referring now to FIG. 14, when the aperator opens the POL application on their respective mobile computing device the operator is presented with a set of menu options. One option is the operator can then request a new load. Wherein requesting a new load transmit avaibility of the operator to the transportation management system. The transportation management system may then use the operator information, including location to calculate and assign the operator to a given lease site and route. Routes are managed by the organization's (company's) POL administrator or administrator of the transportation management system. The operator may receive the message: “Please contact your organization's POL Admin if you do not see routes that should be assigned to you.” The Operator may also receive the message: “Leases and Tanks are managed by organization through Pilot's transportation management system. Please contact your Organization's POL Admin to report needed changes.” These options are tailored to the given organization deploying the transportation management system and the POL may be named accordingly as it relates to branding and marketing.

Continuing with FIG. 14, to request a load, the operator selects “Request New Load” from the main menu.

Next, the operator conducts the following steps:

Step 1: Location information (see FIG. 15) may include:
1. Select route
2. Select lease
3. Select tank
4. Indicate if you witnessed the load or not
5. Tap continue

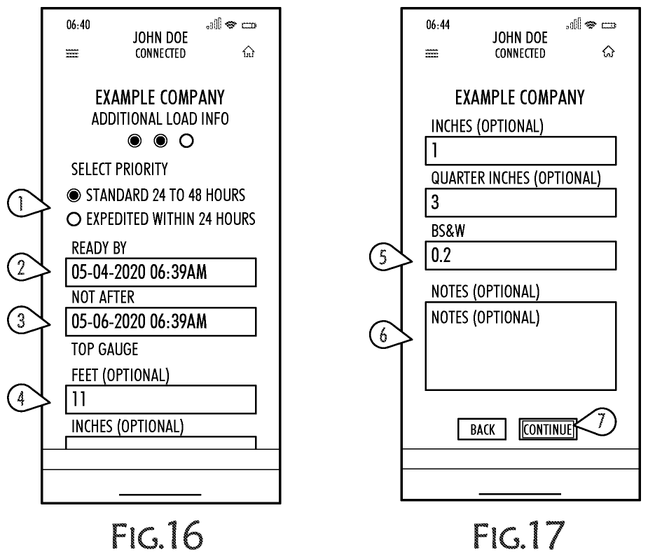

Step 2: Load information (see FIGS. 16-17) may include:
1. Select priority (24 to 48 hours by default or Expedited to within 24 hours)
2. Indicate when will the load be ready by
3. Indicate the latest the load could be picked up—this relates to the selected priority above
4. Enter Top Gauge measurements (optional)—feet, inches, and quarter inches
5. Enter BS&W measurement (required)
6. Enter notes (optional)
7. Select “Continue”

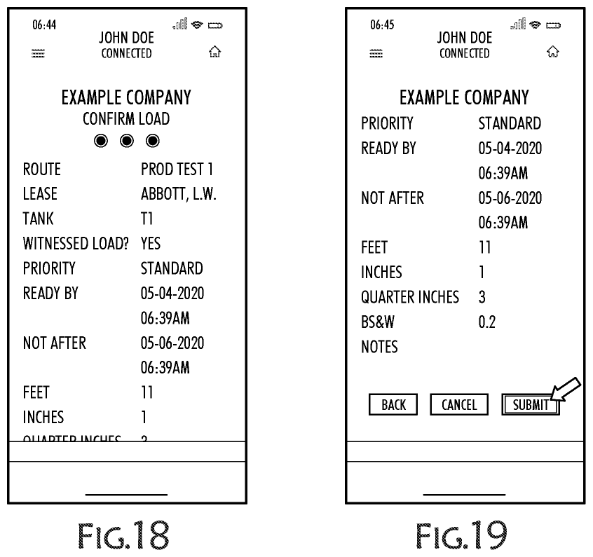

Step 3: Review and Submit (see FIGS. 18-19) may include reviewing a summary of entries and select “Submit” or select the “Back” button to edit the entries. “Cancel” will redirect to the main screen and cancel this new load request entry before submitting.

The Active Loads screen will display load requests with the following statuses:
Requested
Scheduled
In Progress

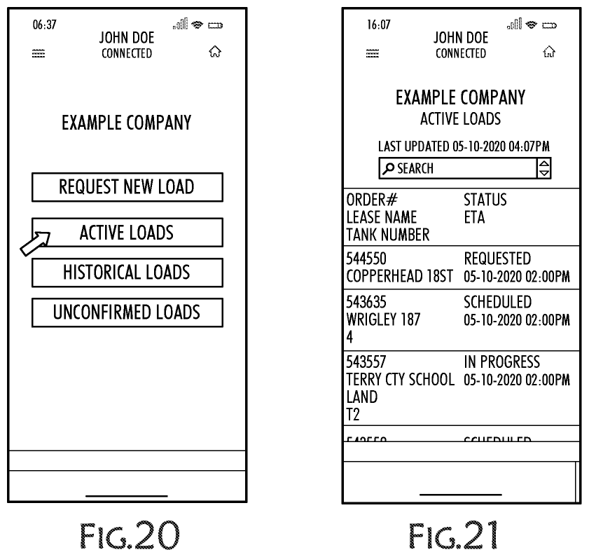

The user can search Active loads (See FIG. 20) by entering an e-Ticket number in the search field (see FIG. 21). Or by entering an order # or other identifier or manually maneuver through the list in a chronological order.

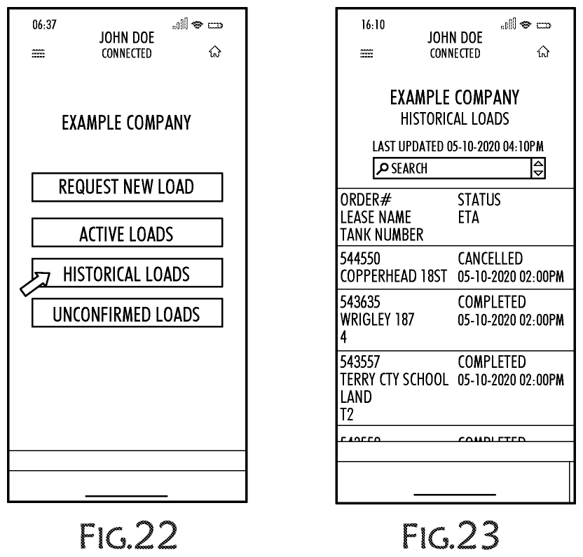

When “historical loads” is selected (FIG. 22), the Historical Loads screen will display load requests (see FIG. 23) with the following statuses
Completed
Cancelled

The status may also include details such as the order number, the lease name, the tank number, as well as any statistics such as duration of route, estimated weight of load, and other fields that will be known by those of skill in the art of oil transport and freight shipping. The statistics within the transportation management system may be provided by a statistics module, wherein the statistics module may run the various statistics over time series data collected from route assignments, operators, and companies to build a knowledge graph and for use with optimization of oil field logistics.

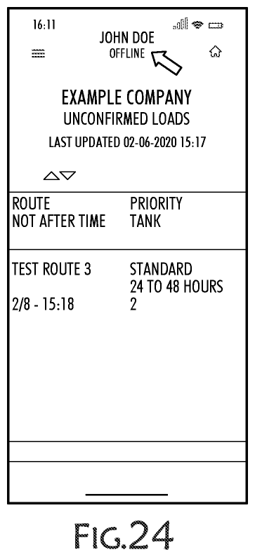

Referring now to FIG. 24 for an illustration of an example embodiment of offline mode in the POL and the transportation management system, and various options available while offline. The Unconfirmed button will be grayed out (inaccessible) when there are not any unconfirmed loads are stored on the device. For Unconfirmed loads/Offline mode, the POL mobile app will switch to offline mode when an Internet connection is unavailable or airplane mode is enabled. Unconfirmed loads are created when a new load is requested while the POL mobile app is in offline mode. Unconfirmed loads are automatically transmitted to Pilot's transportation management system when an internet connection is restored within 24 hours of requesting a load in offline mode. The status of the POL mobile app is clearly indicated at the top of each page. The POL mobile app will automatically resume online status when an internet connection is restored.

The dashboard may be considered to be a management dashboard to regulate access to the transportation management system for authorized user (e.g., registered Admin and operators). In one example the transportation management system works with a dispatch system (which may be a separate system from the transportation management system or incorporated as part of assigning routes) to provide dispatch information to the operators as needed to convey information about routes and leases.

The lease is a contract a company can go onto a property and drill for oil (or other minerals, resources, etc.). The lease may be an actual geographic site with an oil well where oil is loaded into the truck and transported to a storage site or refinery. The trucks are dispatched to go pick up the crude oil from these lease sites, where the oil is allocated to the refinery as a delivery destination. The path from the lease to the delivery destination is considered the route.

The transportation management system is configured to submit orders on behalf of the Admin. The transportation management system may be a separate entity from the owners of the leases or the crude oil on the trucks, but may be associated with a delivery service, which may be enabled by the transportation management system. The mobile app is able to interact with the dispatch system and may be configured to track history, assignments, and track the drivers.

The database may be configured to store pre-populated information once Admins and operators are registered. The database may store admin information, operator information, company information, lease information (names, locations, etc.), refinery information (names, locations, etc.), and/or other information needed for operating the service. A crude hauling division of a business may use a dispatching system associated with the dispatcher.

Through the dispatch system, transportation management system can create lease to destination information, define loads and drivers. For example, it can define 3-5 loads for each driver to deliver during a day. That dispatch system is assigned from that mobile app or portal, which can interact with each other.

The transportation management system may include APIs (application programming interfaces), which are computing interfaces that define interactions between different software applications. The APIs of the transportation management system in the present disclosure may define how signals and messages are handled from the various parties (e.g., different companies and operators). The APIs can define the types of requests that can be made and other various details.

There may be a hierarchy between routes and leases defined within a separate table outside or in conjunction with TMW. The purpose of the portals, apps, and APIs is to display and assign leases and/or routes to a user. The user then uses the app to schedule pick-ups from the set of leases on that route.

The portal is the user assignment to routes and leases. This can be done through “company admin” in a self-service manner. If there is a customer that says, “We want you to haul our crude and we want to use the transportation management system app” (e.g., the oil field logistics module), the transportation management system can say, “Who's your company admin?” The transportation management system sets them up as company admin, and then they can invite users. With a few company admins, the admins can invite other users to their company to use the app by way of an invitation process. The transportation management system logs in passwords, etc. The company admin also sets up routes and leases through the portal.

Once the user has been assigned and has been given an account by the company admin, the user can use the mobile app by using their log-in to then go and schedule “orders” or “scheduled pick-ups” from a lease (site) that is designated on their route. An operator (driver, user) has a route with multiple leases assigned to him and they work through those and schedule the pickups accordingly.

An order may include any amount of information, such as lease location, destination location, amount of oil to pickup, etc. The dispatch system sends to the order to a specific operator. The operator goes to the lease, picks up so many gallons or barrels of crude oil, and delivers it to the refinery, storage area, etc. as requested in the order. This is the exchange from the transportation management system app to the dispatch system. The dispatch system will create the order for the pickup.

There may be a history component for the transportation management system, allowing historical records and data analysis to be performed on historical trip data, including operator performance, company performance, and efficiency such as fuel efficiency, and efficiency in quantity delivered to the destination or delivery address. Also, there is a possibility of doing multiple pickups before a delivery, which is built into the workflow process. This may be part of the dispatch solution.

The portal may be referred to as a management console. There is a subset of the APIs developed to fit in between the portal (which may be a user interface (UI)) and the same set of APIs in between the mobile app and the dispatch system may perform the backend data manipulation and does inserts into the database.

Creating that customer admin portal may include allows the companies to manage all the different customers without the transportation management system involvement. This gives the customers the ability to manage their own internal resources and who to allow access to be able to create these orders in the mobile apps. In this way, the companies can keep track of all the potential operators for all of their customers, which is an aspect of the customer admin portal. There is also a potential use for reporting and executive local reporting. That admin portal creates a relationship to refer to a route, which may include a lease.

The workflow engine allows the customer to create custom workflows and can be custom made for different groups. The transportation management system uses those workflows to follow and mange how an operator (driver) would work through the system. In other embodiments, the transportation management system may have workflow aspects for the mobile app component, which may be built upon an additional “management console,” such as a web app. Users can dynamically design a workflow, hit a submit button, then go to a mobile app and force the mobile app to do a refresh from the backend. It can add additional workflows to the mobile app without having to download a new app. It provides new workflows while releasing a new app.

The user can go into the console and add a new workflow. They might set up a workflow that says, “take a picture, input these five numbers, and then hit submit.” This can be customized by the company admins. The process may send an email regarding the workflow. If an operator wants a workflow that takes an API, the transportation management system provides an input API and an output API. This may include trying to workflow the API, give it the values the user wants to use, and then it causes the APIs to do the processing and the submission of the orders.

There may be a developer creating those workflows using that backend system. For a customer for whom a delivery service is hauling crude oil, the customer does not do any coding themselves, but this can all be done by the development of the transportation management system. The customers, however, enter data to manage their internal employees. This may be similar to vehicle driving service where a customer wants someone to come pick them up at their house and take me some place. This is a similar scenario, except it requests one or more operators to haul crude from one location to another.

Although the present disclosure has been illustrated and described herein with reference to exemplary embodiments providing various advantages, it will be readily apparent to those of ordinary skill in the art that other embodiments may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

Therefore, the following is claimed:

1. A system for oil field logistics utilizing a computer implemented dashboard, comprising:
a vehicle for transporting oil from oil field lease sites to destination locations;
an operator of the vehicle;
a mobile computing device with GPS positioning, wherein the operator is equipped with the mobile computing device;
an administrator;
a transportation management system operatively configured to a computing system, comprising:
a database of oil field lease sites;
a database of registered operators, wherein the database of registered operators is populated by the operators registering for an account;
a route assignment module for assigning available operators to the oil field lease sites;
an operator request module for requesting available oil field lease sites; and
a dashboard operatively configured to the transportation management system, wherein the dashboard has an administrative view and an operator view.

2. The system of claim 1, wherein the transportation management system further comprises a statistics module, wherein the statistics module calculates statistics on the operators.

3. The system of claim 1, wherein the dashboard provides a module for inviting operators under the administrative view.

4. The system of claim 1, wherein the dashboard provides a module for creating operator routes under the administrative view.

5. The system of claim 1, wherein the dashboard provides a module for confirming the operator is at an oil field lease site under the administrative view.

6. The system of claim 1, wherein the dashboard is configured in a server to point to URL.

7. The system of claim 1, wherein the dashboard is configured to a mobile computing application.

8. The system of claim 1, wherein the transportation management system further comprises a communications module for communicating with a plurality of operators.

9. A method for implementing a dashboard for oil field logistics, comprising:
provisioning an operator with a mobile computing device equipped with a GPS module;
accessing on the operator's mobile computing device a transportation management system dashboard, wherein accessing is restricted to the operator view of the dashboard for the transportation management system;
requesting, by the operator, a new oil field load request from the dashboard;
calculating, by the transportation management system, availability of an oil field lease site pickup that corresponds to the operator initiating the oil field load request;
assigning, by the transportation management system, an oil field lease site pickup and delivery destination based on at least the operator's oil field load request; and
confirming, by the operator's mobile computing device and the transportation management system, that the operator has arrived at the oil field lease site pickup destination, wherein confirming displays confirmation on an administrative view of the dashboard.

10. The method of claim 9, further comprising transmitting an invite to an operator from the transportation management system.

11. The method of claim 9, further comprising accepting an invite by the operator from the transportation management system.

12. The method of claim 9, further comprising displaying a historical loads view on the operator's view of the dashboard.

13. The method of claim 9, further comprising managing oil field lease data, wherein managing takes as input into the transportation management system new oil field lease sites.

14. The method of claim 9, wherein provisioning an operator with the mobile computing device equipped with a GPS module further provisions a mobile application with the transportation management system dashboard.

15. The method of claim 9, further comprising provisioning an operator with a mobile computing device and credentials for accessing the operator view of the transportation management system dashboard.
